(19) United States
(12) Patent Application Publication
(10) Pub. No.: US 2020/0186377 A1
(43) Pub. Date: Jun. 11, 2020

(54) ACCESSIBLE OPERATION OF A HOUSEHOLD APPLIANCE

(71) Applicant: BSH HAUSGERAETE GMBH, MUENCHEN (DE)

(72) Inventors: NATALIE BAIER, LUDWIGSBURG (DE); AXEL SCHUENEMANN, SEEBRUCK (DE)

(21) Appl. No.: 16/614,445

(22) PCT Filed: May 7, 2018
(86) PCT No.: PCT/EP2018/061646

§ 371 Date: Nov. 18, 2019

(30) Foreign Application Priority Data
May 17, 2017 (DE) 10 2017 208 297.6

(51) Int. Cl. H04L 12/28; D06F 34/32; G06F 3/16; G06F 3/0488

(52) U.S. Cl. CPC H04L 12/282; G06F 3/04883; G06F 3/167; D06F 34/32

(57) ABSTRACT

An operating device for a household appliance includes an input element; an interface for communication with the household appliance; and a processing device for controlling the household appliance in response to an actuation of the input element. The input element is configured for actuation by visually impaired persons.

The invention relates to the operation of a household appliance. In particular, the invention relates to the accessible operation of a household appliance by a visually impaired person.

### Prior Art

A commercially available household appliance, for instance a washing machine, a tumble dryer or a coffee machine, is generally designed for operation by a normal-sighted person. On account of the increasing number of possible options and operating programs a touch-sensitive monitor (touchscreen) is frequently used for operation, so that dynamic entries, menus or animations can be displayed for easier operation.

Such an operating concept does not cater to visually impaired persons, for instance to significantly short-sighted or long-sighted persons or persons with blurred vision.

EP 1 543 493 B1 relates to a Braille display for the tactile presentation of characters. The Braille alphabet describes a number of characters, each of which is defined by tactile highlighting which is set or unset in a predetermined matrix. If a text is to be shown, a large number of moveable parts is typically required, which can be complicated to manufacture and prone to mechanical errors.

DE 3 403 487 C2 proposes equipping an electrical household appliance with a voice output. An input interface is adjusted accordingly, so that the individual operating elements can be distinguished haptically from one another. In this way the functional versatility of a modern appliance may frequently not be fully utilized.

An object underlying the present invention is to specify an improved technology for accessible operation of a household appliance. The invention achieves this object by means of the subject matters of the independent claims. Subclaims reproduce preferred embodiments.

An inventive operating device for a household appliance comprises an input element; an interface for communication with the household appliance; and a processing facility for controlling the household appliance as a function of an actuation of the input element. In this context the input element is preferably designed for actuation by a visually impaired person.

The operating device can be used both for operation of the household appliance by a normally sighted person and also by a visually impaired person. The operating person may be visually impaired in one eye by less than 100%, less than 80% or less than 50% for instance, or may be completely blind. The visual impairment may be situation-dependent, for instance when a long-sighted person is operating the household appliance in the close-up range. Moreover, the visual impairment may also be age-related or temporary. As a side effect, operation of the household appliance by a sighted or visually impaired person in the dark can also be enabled in an improved manner. The household appliance can comprise a customary user interface which is visual or supported visually for a person with normal vision and the operating device can, if necessary, be used by a visually impaired person. As a result, manufacturing costs of the household appliance cannot be increased or only marginally. The operating device can be integrated into the household appliance or realized separately therefrom. The operating device can be exchanged or additionally provided on the household appliance with another, originally provided operating device. Moreover, the operating device can be originally fitted on the household appliance or retrofitted.

With respect to the further embodiment of the invention, a number of variants are conceivable, which can also be combined with one another.

In some embodiments, the operating device comprises an acoustic output device, wherein the input element preferably comprises a touch-sensitive monitor for displaying a functional surface, and the processing facility is in particular designed to output an acoustic notification of an assigned function in response to an actuation of the functional surface.

In particular, a person who is not completely blind can visually register the functional surface and actuate the same so that he/she receives a notification of the function which is to be triggered as a result. For instance, the notification can be called up by briefly tapping on the functional surface and the function is only triggered if the functional surface is actuated for a longer time or repeatedly. In one particularly preferred embodiment, the processing facility is designed only then to trigger the function if the assigned functional surface has been actuated for a longer predetermined time than outputting of the acoustic notification requires. In other words, the acoustic notification is requested by touching the functional surface and the function can only then be carried out if the person maintains the actuation of the functional surface for longer than the outputting of the notification utilizes.

The acoustic notification can comprise a spoken text, an acoustic signal, a signal sequence or a melody. In a further embodiment, a characteristic noise can also indicate the function. The noise can in particular symbolize or represent activity of the household appliance which is connected with the function.

In some embodiments, the operating device comprises an acoustic output device, wherein the input element preferably comprises a mechanical actuator, which has at least one tactile end position and/or intermediate positions which can be distinguished haptically from one another. In this context the processing facility is preferably designed to output a first acoustic feedback when an intermediate position is reached and/or a second acoustic feedback when the end position is reached. Alternatively, or in addition, the processing facility can be designed to output an acoustic indication of an assigned function of the reached position.

As described above, the acoustic feedback can be embodied differently. In one simple embodiment, only two different acoustic feedbacks are used, wherein an operating person can determine a position of the mechanical actuator from an end position by counting first acoustic feedbacks when the actuator is adjusted. This variant can be easily adjusted to different numbers of intermediate positions. Therefore a menu, optionally also a hierarchical menu, can in particular also be reliably used by a visually impaired person.

The mechanical actuator can comprise a controllable braking facility, wherein the processing facility is preferably designed to actuate the braking facility so that the actuator can assume a predetermined number of actuation steps between a first and a second end position. Here the actuator can in particular be rotatably actuated, for instance in the form of a rotary knob. By means of the braking facility, a force feedback can be output upon actuation, so that in addition or alternatively to the acoustic feedback an operating person receives a haptic feedback relating to an end or intermediate position having been reached.

In some embodiments, the operating device is designed to select and then operate one of several different household appliances. Here dedicated operating elements can be provided for the different household appliances or one of the operating elements can be used for several household appliances. One embodiment is particularly preferred, in which the operating device can be used as far as possible universally for a plurality also of different household appliances. One or more input elements, as described above, are preferably actuated here by means of a user interface, and possibly supported by an output of an acoustic or haptic facility, such that as intuitive an operation of all supported household appliances as possible is enabled. The selection of the household appliance to be operated can be carried out by means of a mechanical selection switch for instance. Alternatively, a household appliance can also be selected by the operating device approaching the household appliance at a predetermined distance. Other variants are likewise conceivable.

In a particularly preferred embodiment, the operating device is designed for autonomous operation and the interface for wireless communication. The operating device can comprise a separate housing and a separate power supply, for instance, and can communicate with the household appliance by means of a conventional wireless technology such as WiMAX, WLAN, Bluetooth or NFC. In a further embodiment, the operating device communicates with a central component, for instance by way of a general information network such as the Internet or a mobile radio network, and the central component communicates on its part with one or more household appliances. The household appliances can be managed jointly by means of the central facility, so that interactions between the household appliances can in particular be supported better. For instance, washing of laundry may require consecutive operation of a washing machine and a tumble dryer. Operator guidance can cater to such sequences. Moreover, the central point can be reached in an improved manner if the operating device is not located in the vicinity of a household appliance, for instance because the user with the operating device is not at home. An alternative operation of the household appliances using another access to the central point can likewise be offered.

In some embodiments, the input element comprises a mechanical actuator, wherein the processing facility is preferably designed to bring the household appliance into a safe state in response to actuation of the input element. The input element can be embodied in particular in the form of a mushroom button or another facility which is easy to actuate. Upon actuation of the input element, one or more household appliances can be brought into a state in which danger from the appliance is minimal. For instance, a user, before he/she leaves his/her home, can set one or more of his/her household appliances into an energy-saving state, in order to save on power. A household appliance which operates with water, for instance a coffee machine or a washing machine, can be actuated in order to securely close a freshwater inflow. In the case of the washing machine, a cleaning container can be emptied of water or wash liquor.

An inventive system comprises a household appliance and the afore-described operating device. It may also include several household appliances and possibly the afore-mentioned central component of the system.

An inventive method for controlling a household appliance comprises steps for scanning an actuation of an input element; outputting an acoustic feedback by way of a function of the household appliance assigned to the actuation; and transferring a control message to the housing appliance, in order to trigger the function. The method can proceed wholly or partially on a processing facility and be present in particular as a computer program, wherein the processing facility can comprise a programmable microcomputer or microcontroller.

The afore-described features of the operating device can be combined freely with one another, so that other embodiments can also be formed with the features, without departing from the scope of the invention. In addition, the features and advantages of the operating device can also be applied analogously to the inventive system and the inventive method.

The invention is described more precisely below with reference to the appended figures, in which:

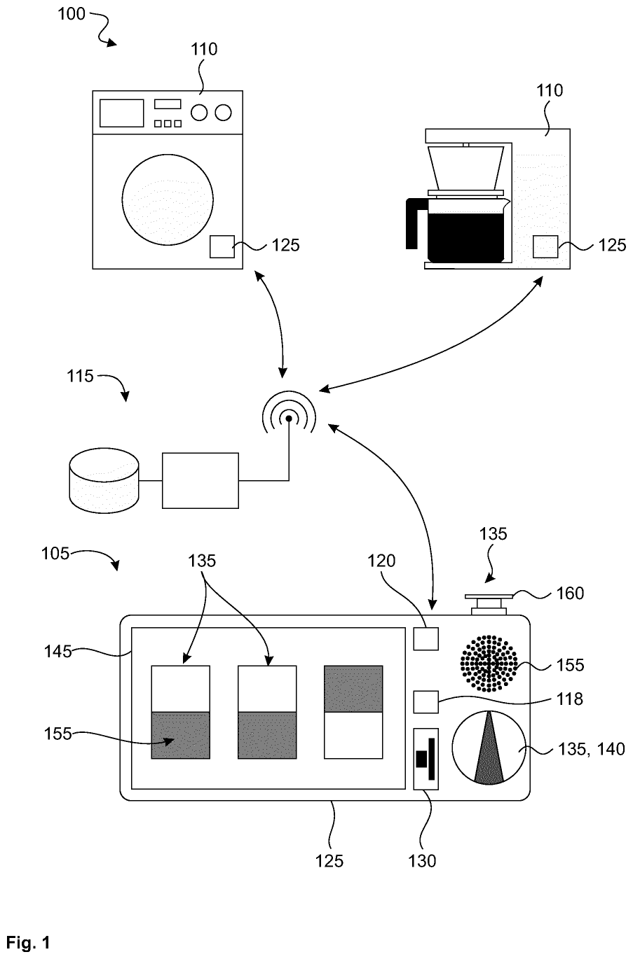

FIG. 1 shows an embodiment of a system with an operating device and a number of household appliances;

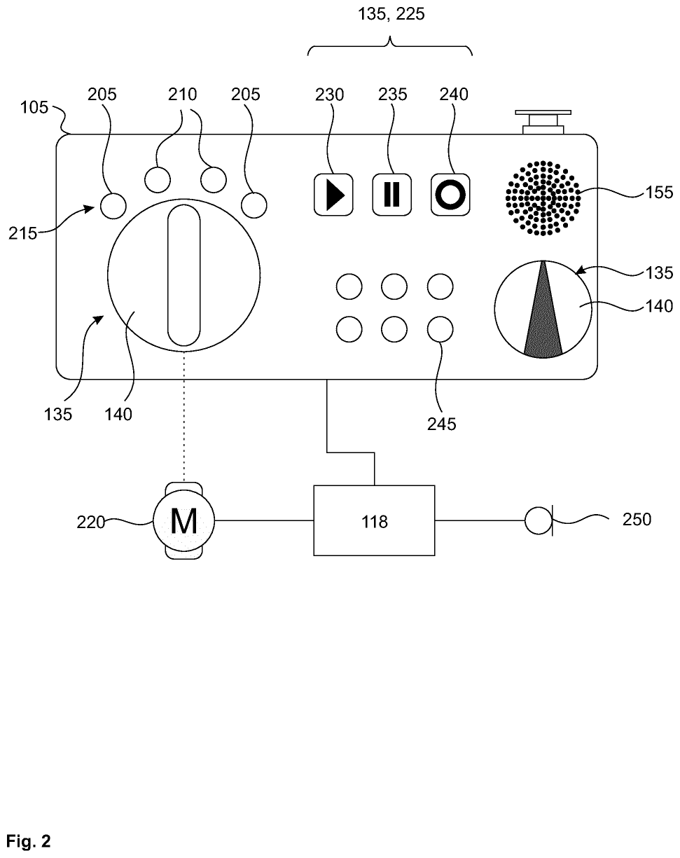

FIG. 2 shows an operating device in a further embodiment;

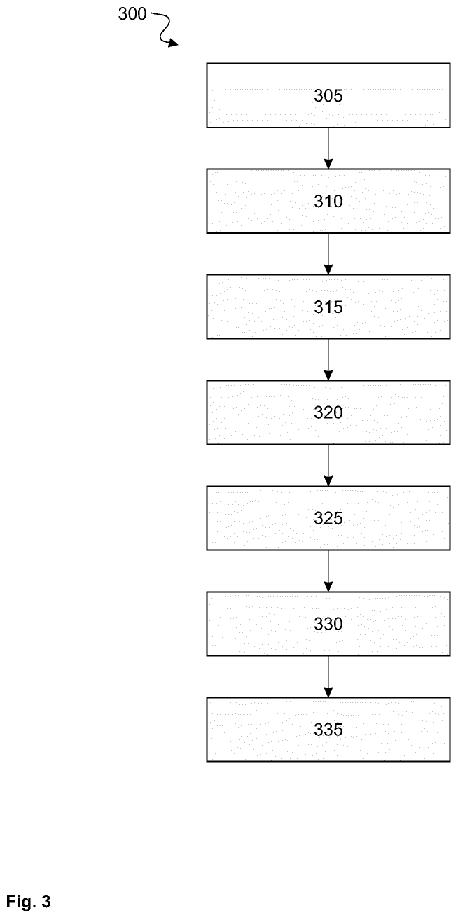

FIG. 3 shows a flow chart of an embodiment of a method for controlling a household appliance; and

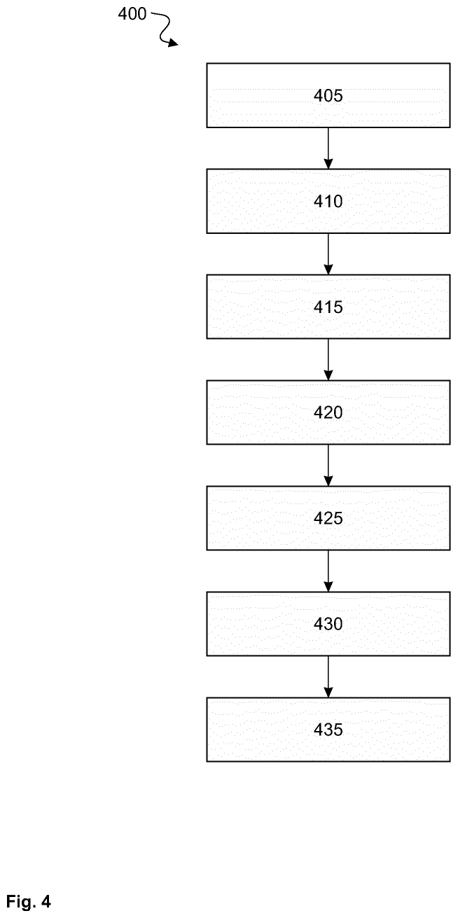

FIG. 4 shows a flow chart of a further embodiment of a method for controlling a household appliance.

FIG. 1 shows a system 100, which comprises an operating device 105, one or more household appliances 110 and optionally a central facility 115. The operating device 105 is designed to communicate with at least one of the household appliances 110 and to control its function. To this end, information can be exchanged in one or in both directions. The operating device 105 can possibly also output a display relating to an operating or operations state of a household appliance 110. The operating device 105 comprises a processing facility 118, which can be embodied in particular as a programmable microcomputer or microcontroller. The operating device 105 and the household appliances 110 can each have an interface 120 which can be embodied in a wired or wireless manner independently of one another. The operating device 105 can communicate directly or indirectly with a household appliance 110 via the central facility 115. Parts of a communication link between the operating device 105 and the central facility 115 or from these to one of the household appliances 110 can be embodied in a wired or wireless manner in each case. For instance, the communication between the operating device 105 and the central facility 115 can be carried out wirelessly by means of Bluetooth or WLAN, while the communication between the central facility 115 and a household appliance 110 can be carried out in a wired manner via part of the Internet and then wirelessly, for instance by way of Bluetooth. The central facility 115 can be embodied in particular as a processing facility, which can be reached by way of a communication network such as the Internet or a mobile radio network. In one embodiment, the central facility 115 comprises a server, which, in a further embodiment, can also be realized as a service or cloud when abstracted from its place of installation.

The operating device 105 is designed to facilitate or enable operation of the household appliance 110 in particular by a visually impaired person. Purely by way of example in terms of household appliances 110, FIG. 1 shows a washing machine 110 in the left region and a coffee machine 110 in the right region. Other household appliances 110 can likewise be controlled, for instance a cooker, an oven, a toaster, an autonomous vacuum cleaner etc.

The operating device 105 is preferably designed for autonomous operation and can comprise a separate housing 125 and a separate power supply 130. The operating device 105 can be handled separately, or, in a further embodiment, integrated into one of the household appliances 110. The operating device 105 preferably comprises at least one input element 135. In the embodiment shown, a first input element 135 is formed by a mechanical actuator 140, here a rotary switch, a rotary knob or a rotary wheel. A corresponding sliding element can likewise be used. The actuator 140 can, as cited below in more detail, have a number of positions which can be distinguished haptically from one another. For instance, the actuator 140 can be used to select one of the household appliances 110 for operation by the operating device 105. The position of the actuator 140 can be identified by touch, by the rotary knob not being designed to be radially symmetrical, but instead having a pointer, a knob or a lug which can be identified by touch.

In the embodiment shown a further input element 135 is formed by a touch-sensitive monitor (touchscreen) 145, on which a functional surface 150 is shown. The functional surface 150 is preferably shown large, with a significant visual contrast and at an adequate distance from an adjacent functional surface 150, in order to facilitate operation by a merely partially visually impaired person, who can visually resolve at least rough structures. A function which is assigned to the functional surface 150 can be triggered by pressing or swiping across the respective household appliance 110.

An acoustic output device 155 is further preferably provided, which can be designed to output a sound, a noise or spoken words. The output device 155 can be used to output a notification of a function which is assigned to a functional surface 150. A position of the actuator 140 can also be communicated by an acoustic notification by means of the output device 155. The actuator 140 can in particular have a number of discrete positions, the assumptions of which can be accompanied in each case by a corresponding item of acoustic information. As a result, a numerical entry can in particular be facilitated, if, for instance, the third position of the actuator 140, based on a predetermined position, is to be set.

A further input element 135, which is currently embodied by way of example as a mushroom button 160, can be designed to trigger a safety function on one or more household appliances 110. The safety function can in particular bring the household appliance 110 into a safe state. This is usually identified by a minimal power consumption and possibly by establishing a physical condition. The condition can in particular comprise the positions of one or more actuators of the household appliance 110, in order to safely store a potentially harmful medium, with which the household appliance 110 operates, for instance a liquid. By pressing the mushroom button 160, a number or all of the household appliances 110 can be rendered safe before leaving a shared household, for instance. A feedback indicating which household appliances 110 have been brought successfully into the safe state can be displayed by means of the output device 155.

FIG. 2 shows an operating device 105 in a further embodiment, which can be combined with that in FIG. 1. The operating device 105 shown has a further rotatable actuator 140 instead of the touchscreen 145, for instance. The actuator 140 can be brought into one of several predetermined positions, wherein currently by way of example a first and a second end position 205 and several intermediate positions 210 lying therebetween are provided. The assumption of one of the positions 204, 210 can be displayed by means of an assigned display facility 215. The display facility 215 can comprise a lamp or an LED, for instance. It is further preferred that the actuator 140 is designed to automatically mechanically engage with the positions 205, 210, so that a haptical feedback can be communicated when one of the positions 205, 210 is reached. In one embodiment, a mechanical, in particular spring-loaded latching mechanism is provided for this purpose.

In another embodiment, a braking facility 220 is coupled mechanically to the actuator 140, and the processing facility 118 is designed to control the braking facility 220 so that a similar latching effect is produced. The braking facility 220 can comprise for instance a mechanical friction brake or an electric motor, in particular a stepping motor. The braking facility 220 can be designed to indicate or prevent a movement beyond one of the end positions 205 as a result of increased brake force. The braking facility 220 can be used, dependent on operating context, to realize different numbers of positions 205, 210 of the actuator 140. As a result, a hierarchical menu can be run through by means of the actuator 140 or a selection of a predetermined number of options can be offered. A menu entry to be selected can be carried out for instance by pressing the actuator 140 or another input element 135. The position of the actuator 140 is also preferably tactile, for instance as a result of the vertical handle element indicated in FIG. 1, a directional arrow, an indicator or a lug. In one embodiment, the braking facility 220 in the form of the electric motor can also be used to drive the actuator 140.

For instance, upon entry into a selection of n elements the actuator 140 can be automatically brought into a first (or last) position 205, 210 before a user sets another position.

A notification of an assumed position 205, 210 can also be output by way of the acoustic output device 155. For instance, a first acoustic feedback, in the form of a low tone for instance, can be output when an end position 205 is reached, and a second acoustic feedback, in the form of a high tone for instance, can be output when an intermediate position 210 is reached. A user who knows for instance that the third position 205, 210 is to be set in the clockwise direction from the assumed end position 205 can rotate the actuator 140 in the provided direction until he/she has obtained three acoustic feedbacks. The first and second feedbacks can differ still further from one another, for instance also with respect to a volume or a length. In addition or alternatively, a notification of a selected position 205, 210 or a function of a household appliance 110 linked thereto, can be output by way of the acoustic output device 155.

In one embodiment, a mechanical end stop is not provided for the actuator 140. The information that a provided end position 210 is reached can only be communicated to a user by means of the acoustic feedback. For instance, the user can bring the actuator 140 out of the first end position 205 by rotating in one direction firstly into one or a number of consecutive intermediate positions 210 and finally into the second end position 205. The reaching of each intermediate position 205 and the second end position 210 is preferably signaled acoustically. A further rotation of the actuator 140 in the same direction can be possible mechanically, wherein a value set or selected by the actuator 140 can however change no further. A selected element of a list or a set parameter, for instance a washing temperature of a washing machine, can remain on the last selected value. When the actuator 140 is further rotated, acoustic signals can be repeatedly output, which indicate that the end position 210 has already been reached. Following any rotary movement beyond the end position 210, an intermediate position 205 or the other end position 210 can be reached immediately by rotation about a position 205, 210 in the opposite direction.

The operating device 105 shown additionally comprises a number of further input elements 135 in the form of buttons or keys 225. Three specially shaped keys 225 are arranged in the upper region of the display in FIG. 2, each of which can be assigned to a predetermined, fixed purpose and in each case support a tactile marker on its top side, which indicates the function. One first such key 230 is for instance assigned to a start function, a second key 235 to a pause function and a third key 240 to a stop function. The tactile symbols shown on the keys 230 to 240 are embodied purely by way of example and can also be embodied otherwise. The start key 230 can be used to control a household appliance 110 in order to begin a function or a sequence, the operation of the household appliance 110 can be interrupted by means of the pause key 235 and then reassumed, and the function or task of the household appliance 110 can be interrupted by means of the stop key 240. Other functions or assignments are likewise possible.

Furthermore, additional input elements 135 in the form of buttons or switches 245 are shown in the embodiment shown. In one embodiment, one of the buttons 245 can be linked with a selectable function of a household appliance 110, so that the pressing of the button 245 triggers the function. The assignment may also be dynamic, by a button 245, in the context of different household appliances 110, being able to trigger different functions, for instance.

Optionally, an acoustic input device 250 can also be provided. Furthermore, a user can carry out in particular an acoustic input. This input can be assigned to a function of a household appliance 110. For this purpose, the processing facility 118 can implement a voice recognition. An input speech command can also be transmitted to the central facility 115 and analyzed there. The result of the analysis can immediately result in a control of a household appliance 110 or be fed back to the operating device 105 in order to be able to be further processed or output there.

FIG. 3 shows a flow chart of a method 300 for controlling a household appliance 110. The method 300 is designed in particular to run on the operating device 105 and more precisely on the processing facility 118 and can be present as a computer program product.

The method 300 shown is based on an operating device 105 with touch-sensitive monitor 145, as shown in FIG. 1.

In an optional first step 305, one of several household appliances 110 can be selected. To this end, an actuator 140 in particular can be used, the position of which supports an immediate haptical feedback. One or more functional surfaces 150 are then shown on the touch-sensitive monitor 145. Actuation of a functional surface 150 is carried out by touch in one step 310. Thereupon, in a step 315, a notification of the function of the selected household appliance 110 assigned to the functional surface 150 is output. This can be carried out in particular as an acoustic, preferably spoken text message by means of the acoustic output device 155.

If the actuation of the functional surface 150 is carried out throughout the entire output duration of the notification and possibly throughout a further predetermined time, the assigned function is selected in a step 320. In a step 325, a corresponding request for carrying out the function is transferred to the household appliance 110. A feedback of the household appliance 110 can possibly be received in a step 330 and output in a step 335.

FIG. 4 shows a further method 400 for accessible control of a household appliance 110 by means of a control device 105. In this context an embodiment with an actuator 140 is assumed, which can be influenced by means of a braking facility 220, as explained in more detail above with reference to FIG. 2.

In a first step 405, one of several household appliances 110 can be selected, as cited above with respect to step 305 of the method 300.

In a step 410, a number of positions 205, 210 is determined, which are available in a present operating step for the household appliance 110. At least two end positions 205 are preferably provided, between which one or more intermediate positions 210 can lie. If the braking facility 220 is designed to actively influence the position of the actuator 140, the actuator 140 can also be moved into a predetermined position 205, 210. This position can comprise in particular one of the end positions 205.

In a step 415, the position of the actuator 140 is captured and the braking facility 220 is activated so that a latching effect is produced on the predetermined positions 205, 210. An assigned, acoustic feedback is preferably output by means of the acoustic output device 155 each time one of the positions 205, 210 is assumed. The feedback is preferably selected so that an operator is able to count the number of feedbacks when the actuator 140 is actuated, in order to identify a numerically indicated position 205, 210. Actuation of the actuator 140 beyond one of the end positions 205 is preferably prevented by means of the braking facility 220. An acoustic warning can additionally be output.

The subsequent steps 420 to 435 correspond to the functions 320 to 335 of the method 300.

The explanations made with reference to the figures are understood to be purely illustrative and not restrictive. The disclosed features can also be combined with one another differently than specified, in order in this way to provide optimized embodiments for the application.

### REFERENCE CHARACTERS

100 System

105 Operating device

110 Household appliance

115 Central facility

118 Processing facility

120 Interface

125 Housing

130 Power supply

135 Input element

140 Actuator

145 Touch-sensitive monitor (touchscreen)

150 Functional surface

155 Acoustic output device

160 Mushroom button

205 End position

210 Intermediate position

215 Display facility

220 Braking facility

225 Key

230 Start key

235 Pause key

250 Stop key

245 Button

250 Microphone

300 Method

305 Select household appliance

310 Touch functional surface

315 Output notification

320 Select function

325 Transfer request

330 Receive feedback

335 Output notification of feedback

400 Method

405 Select household appliance

410 Determine number of positions. Optionally: Bring the actuator into the predetermined position

415 Capture position, actuate braking facility and output feedback

420 Select function

425 Transfer request

430 Receive feedback

435 Output notification of feedback

1-10. (canceled)

11. An operating device for a household appliance, the operating device comprising:
an input element, said input element being configured for actuation by a visually impaired person;
an interface for communication with the household appliance; and
a processing facility for controlling the household appliance in dependence on an actuation of the input element.

12. The operating device according to claim 11, further comprising an acoustic output device, and said input element having a touch-sensitive monitor providing a functional surface, and wherein said processing facility is configured to output an acoustic notification of an assigned function in response to an actuation of said functional surface.

13. The operating device according to claim 12, wherein said processing facility is configured only then to trigger the assigned function when said functional surface has been actuated for a longer predetermined time than an outputting of the acoustic notification requires.

14. The operating device according to claim 11, further comprising an acoustic output device, and wherein said input element comprises a mechanical actuator, which has at least one tactile end position and intermediate positions that are distinguishable from one another haptically, and wherein said processing facility is configured to output a first acoustic feedback upon reaching one of the intermediate positions and a second acoustic feedback upon reaching the end position.

15. The operating device according to claim 14, wherein said actuator comprises a controllable braking device and said processing facility is configured to actuate said braking device so as to enable said actuator to assume a predetermined number of actuation steps between a first end position and a second end position.

16. The operating device according to claim 11, wherein said operating device is configured to select and then operate one of several different household appliances.

17. The operating device according to claim 11, wherein said operating device is configured for autonomous operation and said interface is configured for wireless communication.

18. The operating device according to claim 11, wherein said input element comprises a mechanical actuator and said processing facility is configured to bring the household appliance into a safe state in response to an actuation of said input element.

19. A system, comprising a household appliance and an operating device according to claim 11.

20. A method for controlling a household appliance, the method comprising:
scanning for an actuation of an input element;
outputting an acoustic feedback by way of a function of the household appliance assigned to the actuation; and
transmitting a control message to the household appliance in order to trigger the function.
